(19) United States
(12) Patent Application Publication
(10) Pub. No.: US 2008/0180031 A1
(43) Pub. Date: Jul. 31, 2008

(54) Device for remediation of gaseous and aerosol streams

(75) Inventor: Alexander Pokryvailo, Hauppauge, NY (US)

Correspondence Address: BODNER & O'ROURKE, LLP, 425 BROADHOLLOW ROAD, SUITE 108, MELVILLE, NY, 11747, US

(73) Assignee: Spellman High Voltage Electronics Corporation, Hauppauge, NY (US)

(21) Appl. No.: 12/009,263

(22) Filed: Jan. 17, 2008

Related U.S. Application Data
(60) Provisional application No. 60/881,197, filed on Jan. 19, 2007.

(51) Int. Cl. H01J 15/02

(52) U.S. Cl. 315/111.91

(57) ABSTRACT

A device for remediation of gaseous or aerosol streams includes an elongated duct, at least one high potential electrode and at least one low potential electrode. The elongated duct defines a bore through which axially flows a gaseous or aerosol stream which is treated by the device to remove pollutants or particulates therefrom. A shaft rotatable within the bore of the duct includes a plurality of pins extending radially therefrom, the shaft and the pins constituting the high potential electrode. The duct may similarly include a plurality of pins extending radially into the interior bore of the duct, whereby the duct and the pins constitute the low potential electrode. The shaft is rotated by a motor relative to the duct, or the duct and shaft may be rotated together by the motor. The high and low potential electrodes are connected to a high voltage power source to effect a corona discharge between the high and low potential electrodes.

### CROSS-REFERENCE TO RELATED APPLICATIONS

This application is related to U.S. Provisional Application Ser. No. 60/881,197, filed on Jan. 19, 2007, and entitled “Device for Remediation of Gaseous and Aerosol Streams”, the disclosure of which is incorporated herein by reference. This application claims the benefit of priority under 35 U.S.C. 119 and/or 35 U.S.C. 120 to the aforementioned related provisional application.

### BACKGROUND OF THE INVENTION

1. Field of the Invention

This invention is related to the precipitation of particulates and removal of pollutants from gas and aerosol streams, such as coming out of chimneys of power plants and exhausts of other combustion installations, effluent tracts of semiconductor processing facilities, painting facilities, food-processing plants and the like.

2. Description of the Prior Art

Effluent gases containing sulfur dioxide (SO₂), and/or nitrogen oxides (NOₓ), and/or particulate matter and/or volatile organic compounds (VOCs), sometimes in an aerosol phase, are generated from many sources including power plants, various combustion installations, e.g., diesel engines, steel plants, paper mills, landfills, painting and semiconductor plants, and the like. In the prior art, many processes are known for the removal of these pollutants from the effluent gas before they are released to the atmosphere. For example, many coal-burning electric power utilities utilize wet or dry scrubbers for SO₂ removal and cyclones, electrostatic precipitators, catalytic converters for NOₓ removal, etc. Pulsed nanosecond corona (PC) was suggested for the simultaneous removal of particulates and NOₓ and SO₂, such as disclosed in U.S. Pat. No. 4,695,358, which issued on Sep. 22, 1987 to A. Mizuno, et al., and which is entitled “Method of Removing SO₂, NOₓ and Particles from Gas Mixtures Using Streamer Corona”, the disclosure of which is incorporated herein by reference, as well as for destruction of VOC, such as disclosed by Pokryvailo, A., Wolf, M., Yankelevich, Y., et al., in an article entitled “High-Power Pulsed Corona for Treatment of Pollutants in Heterogeneous Media”, IEEE Transactions on Plasma Science, Vol. 34, No. 5, pp. 1731-1743, October 2006, the disclosure of which is incorporated herein by reference. The method disclosed in the Pokryvailo et al. article also makes possible the remediation of liquid streams by the atomization of the polluted liquids with the following processing by PC in the aerosol phase. PC demonstrated high removal efficiency, but the cost of pulsed power supplies (PPS) generating nanosecond pulses remains prohibitively high for large-scale applications.

With the purpose of refraining from using such PPS, a number of inventors and scientists proposed to use DC coronas in conjunction with a high velocity gas flow, typically in the range of 50-100 meters per second (m/s), such as disclosed in U.S. Pat. No. 4,698,551, which issued on Oct. 6, 1987 to E. D. Hoag, and which is entitled “Discharge Electrode for a Gas Discharge Device”; an article authored by Yu. Akishev, O. Goossens, T. Callebaut et al., and which is entitled “The Influence of Electrode Geometry and Gas Flow on Corona-To-Glow and Glow-To-Spark Threshold Currents in Air”, J. Phys. D: Appl. Phys. 34 (2001)2875-2882; and an article authored by C. Ren, T. Ma, and D. Wang, and entitled “Stable and Diffuse Atmospheric Pressure Glow Plasma in a Multipoint-To-Plane Configuration in Air”, IEEE Transactions on Plasma Science, Vol. 33, No. 1, pp. 210-211, February 2005, the disclosure of each of which is incorporated herein by reference. Such a flow stabilizes corona discharge bringing it closer to a glow discharge mode and allowing for greater specific power be deposited in the treated media. These devices require high power gas compressors and for that reason are not suitable for large installations.

### SUMMARY OF THE INVENTION

It is an object of the present invention to provide a cost-efficient device for the simultaneous removal of particulates and noxious pollutants from various exhaust streams.

It is further object of the present invention to provide a device for remediation of gaseous and aerosols streams which overcomes the inherent disadvantages of known devices and methods such as described previously.

There is thus provided in accordance with the present invention a combined precipitation and cleaning device comprising a duct conducting a polluted stream therethrough, a set of high potential electrodes and a set of low potential electrodes, the high and low potential electrodes being accommodated within the duct, the electrodes being connected to a source of high voltage, and means for providing fast velocity gas flow in the vicinity of said electrodes, the means being implemented as a mechanism for rotation of the set of low potential electrodes, or of the set of high potential electrodes, or both, in the opposite or in the same direction.

In one non-limiting preferred embodiment of the invention, the duct for conducting a polluted stream is a revolvable cylinder encompassing the low and high potential sets of electrodes, the low and high potential sets of electrodes being a plurality of wire-shaped electrodes arranged in the axial direction of the cylinder, at equal angles in its azimuthal direction, the low potential wires being attached to the cylinder, and the high potential wires being attached to a shaft coaxial to the cylinder, both the shaft and the cylinder being connected to motors revolving them in the same or in the opposite direction, preferably with the same angular speed. In this embodiment, the electrodes are connected to a high voltage source, and the distance between adjacent counterparts of the high and low potential wires is on the order of about 5 centimeters to about 10 centimeters, typically, for a 100 kV (kilovolt) voltage level.

In still another non-limiting preferred embodiment of the invention, the duct itself is the low voltage electrode having a cylindrical shape, and the set of high potential electrodes is a plurality of wire-shaped electrodes arranged in the axial direction of the cylinder, at equal angles in its azimuthal direction.

In another non-limiting embodiment of the invention, the duct for conducting a polluted stream is a cylinder with the set of low potential electrodes attached to its internal surface, the set of low potential set electrodes being a plurality of pin-shaped electrodes arranged in a multiplicity of staggered rows substantially equidistantly and angularly displaced from one another, extending radially outwardly from the interior surface of the cylinder. In this embodiment, the set of high potential electrodes is a plurality of pin-shaped electrodes arranged in a multiplicity of staggered rows on a conducting shaft situated coaxially to the cylinder, and extending radially outwardly from the outer surface of the shaft, the interior surface of the cylinder and the exterior surface of the shaft being separated by a distance that is greater than the individual lengths of the pin-shaped high potential and low potential electrodes, the individual length of the pin-shaped electrodes being typically about 10 centimeters to about 20 centimeters, by a gap that substantially ensures the absence of voltage breakdowns, the gap being typically about 5 centimeters to about 10 centimeters for a 100 kV (kilovolt) voltage level, adjacent pin-shaped electrodes of the opposite polarities overlapping one another in the radial direction, and the overlapping adjacent, opposite polarity pin-shaped electrodes being spaced in the axial direction by a gap that substantially ensures corona discharge formation, wherein each of the shaft and the cylinder is connected to a respective motor, or to the same motor for rotation in either the same direction or in opposite directions.

In another non-limiting embodiment of the invention, the duct for conducting a polluted stream is a cylinder encompassing the sets of low and high potential electrodes, the set of low potential electrodes being a plurality of pin-shaped electrodes arranged in a multiplicity of staggered rows substantially equidistantly and angularly displaced from one another on a rotating conducting shaft, and extending radially outwardly from the exterior surface of the rotating shaft. In this embodiment, the shaft is driven at relatively high revolutions by a motor. The set of high potential electrodes is a plurality of pin-shaped electrodes arranged in a multiplicity of staggered rows on a stationary conducting shaft and extending radially outwardly from the exterior surface of the shaft, the rotating and stationary shafts being parallel to each other and separated by a distance that is greater than the individual lengths of the pin-shaped electrodes, the individual length of the pin-shaped electrodes being typically about 10 centimeters to about 20 centimeters, by a gap that substantially ensures the absence of voltage breakdowns, the gap being typically about 5 centimeters to about 10 centimeters for a 100 kV (kilovolt) voltage level, the adjacent pin-shaped electrodes of the opposite polarities overlapping one another in the radial direction, and the overlapping, adjacent, opposite polarity pin-shaped electrodes being spaced in the axial direction by a gap that substantially ensures corona discharge formation, and wherein the electrodes are connected to a high voltage source.

In still another non-limiting embodiment of the invention, both shafts of the embodiment described in the preceding paragraph are rotated in the same direction, clockwise or counterclockwise, or in opposite directions.

In yet another non-limiting embodiment of the invention, solid plate, non-electrically conducting separators, with adjacent separators being spaced apart axially from one another, are connected to and extend outwardly from the interior surface of the duct in a direction perpendicular to the shafts' axes in such a way as to block the passage of the polluted stream through the side regions of the duct, wherein adjacent pin-shaped electrodes of opposite polarity do not substantially overlap.

In yet another non-limiting embodiment of the invention, the duct is a revolvable cylinder, the set of low potential pin-shaped electrodes is mounted to the interior surface of the duct substantially equidistantly and angularly displaced from one another, the set of high potential pin-shaped electrodes are mounted to the exterior surface of a shaft situated coaxially within the duct, and wherein the duct and shaft are connected to a motor rotating them at the same or different rotational speed and direction.

In yet another non-limiting preferred embodiment of the invention, both the duct having a cylindrical form and the low and high potential electrodes are segmented in the axial direction, each segment being rotated in a direction opposite to a direction of rotation of its neighboring (adjacent) counterpart or counterparts.

In yet another non-limiting preferred embodiment of the invention, with the objective to eliminate the movement of the high potential electrodes, the duct is divided into three axially disposed portions, adjacent portions being interconnected by bearings to allow a relative rotation between them. The two axially outer portions of the duct are stationary and are grounded, and constitute the high potential electrodes of this embodiment. The middle portion of the duct constitutes the low potential electrode and is rotated by a motor. In an alternative arrangement for this embodiment, the stationary outer portions of the duct may constitute the low potential electrodes, and the rotatable middle portion of the duct may constitute the high potential electrode, with either of the middle portion or the end portions of the duct being grounded.

In yet another non-limiting preferred embodiment of the invention, the high potential electrode assembly comprising a shaft and pins attached to the shaft and situated within the duct is immovable, and the grounded low potential electrode assembly comprising another shaft and pins attached to the shaft and situated within the duct is rotatable and connected to a motor.

In yet another non-limiting preferred embodiment of the invention, with the purpose of increasing the device treatment capacity, the high and low potential corona discharge electrode assemblies are arranged in a checker mesh structure, with the high potential and low potential electrode assemblies being installed within the duct in interleaving nodes, the high potential electrode assemblies comprising shafts and pins attached to the shafts which are immovable, and the grounded, low potential electrode assemblies comprising other shafts and pins attached to the shafts which are rotatable and connected to one or more motors.

It will be understood by those skilled in the art that the terms “pin” and “wire” as used herein means any of the known and conventional wire electrodes used for producing corona discharges, including but not limited to, wires of various cross-sectional shapes, knife-shaped, saw-shaped, barbed wire electrodes, electrodes covered by a dielectric, such as ceramics, and the like.

The invention accordingly comprises the device possessing the construction, combination of elements, and arrangement of parts which are exemplified in the following detailed disclosure with figures, and the scope of the application of which is indicated in the claims.

### BRIEF DESCRIPTION OF THE DRAWINGS

To facilitate an understanding of the present invention, some preferred embodiments of the invention will be described, by way of non-limiting examples only, with reference to the accompanying drawings, in which:

FIG. 1A is a longitudinal cross-sectional view of a first embodiment of a device constructed in accordance with the present invention for the remediation of gaseous and aerosol streams.

FIG. 1B is a transverse cross-sectional view of the first embodiment of the present invention shown in FIG. 1A, taken along line 1B-1B of FIG. 1A.

FIG. 2A is a longitudinal cross-sectional view of a second embodiment of a device constructed in accordance with the present invention for the remediation of gaseous and aerosol streams.

FIG. 2B is a transverse cross-sectional view of the second embodiment of the present invention shown in FIG. 2A, taken along line 2B-2B of FIG. 2A.

FIG. 3A is a longitudinal cross-sectional view of a third embodiment of a device constructed in accordance with the present invention for the remediation of gaseous and aerosol streams.

FIG. 3B is a transverse cross-sectional view of the third embodiment of the present invention shown in FIG. 3A, taken along line 3B-3B of FIG. 3A.

FIG. 4A is a longitudinal cross-sectional view of a fourth embodiment of a device constructed in accordance with the present invention for the remediation of gaseous and aerosol streams.

FIG. 4B is a transverse cross-sectional view of the fourth embodiment of the present invention shown in FIG. 4A, taken along line 4B-4B of FIG. 4A.

FIG. 5 is a longitudinal cross-sectional view of a fifth embodiment of a device constructed in accordance with the present invention for the remediation of gaseous and aerosol streams.

FIG. 6A is a longitudinal cross-sectional view of a sixth embodiment of a device constructed in accordance with the present invention for the remediation of gaseous and aerosol streams.

FIG. 6B is a transverse cross-sectional view of the sixth embodiment of the present invention shown in FIG. 6A, taken along line 6B-6B of FIG. 6A.

FIG. 7 is a longitudinal cross-sectional view of a seventh embodiment of a device constructed in accordance with the present invention for the remediation of gaseous and aerosol streams.

FIG. 8 is a longitudinal cross-sectional view of an eighth embodiment of a device constructed in accordance with the present invention for the remediation of gaseous and aerosol streams.

FIG. 9 is a longitudinal cross-sectional view of a ninth embodiment of a device constructed in accordance with the present invention for the remediation of gaseous and aerosol streams.

FIG. 10 is a transverse cross-sectional view of a tenth embodiment of a device constructed in accordance with the present invention for the remediation of gaseous and aerosol streams.

### DETAILED DESCRIPTION OF THE PREFERRED EMBODIMENTS

In accordance with the general concept of the present invention, a device for the remediation of gaseous and aerosol streams includes one or more high potential electrodes and one or more low potential electrodes which are separated from the high potential electrodes by a predetermined distance. The high potential electrodes and the low potential electrodes are connected to a high voltage source. The spacing between the low potential electrodes and the high potential electrodes causes a corona discharge between the electrodes to ionize the gaseous or aerosol stream flowing therebetween.

In conventional devices, the spacing had to be maintained great enough to prevent arcing between the low potential electrodes and the high potential electrodes, or the voltage of the high voltage source had to be kept low enough to prevent such arcing, depending upon the spacing between the high potential electrodes and the low potential electrodes. With the present invention, however, because either the high potential electrodes are rotated, or the low potential electrodes are rotated, or both are rotated, a higher voltage may be applied between the high voltage electrodes and the low voltage electrodes, and the spacing between the high voltage electrodes and the low voltage electrodes may be made smaller, than in conventional devices, with a concomitant increase in current, to create a corona discharge between the opposite polarity electrodes without arcing occurring between the electrodes. Thus, the present invention more efficiently removes particulates from the gaseous or aerosol stream flowing through it.

Furthermore, the rotation of the high potential electrodes or the low potential electrodes, or both, helps to stir the gaseous or aerosol stream flowing through the device, thereby increasing the exposure of the stream to the corona discharge between the high voltage electrodes and the low voltage electrodes, which further helps in the removal of particulates and not just pollutants from the gaseous or aerosol stream flowing through the device.

The various embodiments of the present invention described in detail below are presented to facilitate an understanding of the basic concepts of the invention described above and should not be viewed as limiting the many possible ways of carrying out the present invention that may become evident to one skilled in the art from the disclosure of the present invention and the description of the various embodiments presented herein.

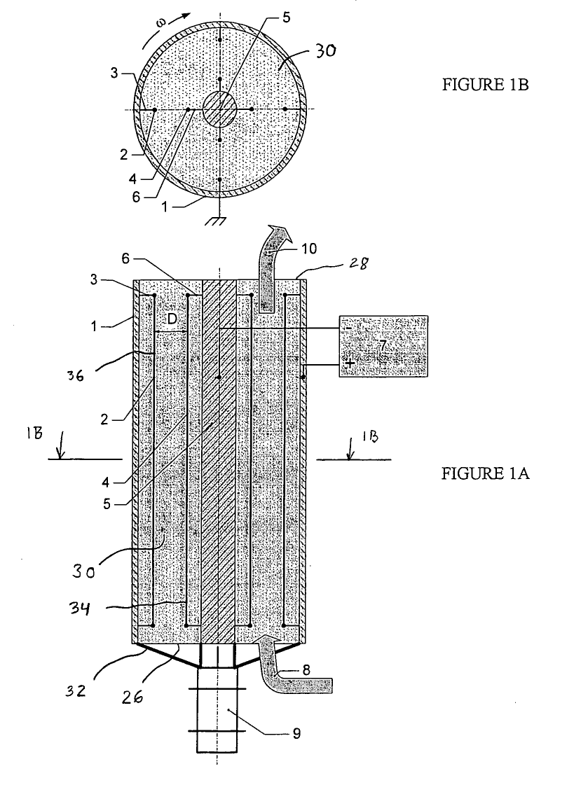

Turning initially to FIGS. 1A and 1B, a first embodiment of the present invention will now be described. An elongated duct 1 has a first open axial end 26 and a second open axial end 28 situated opposite the first open axial end 26, and defines a bore 30 extending axially through the interior of the duct 1 between and in communication with the first open axial end 26 and the second open axial end 28. The bore 30 is provided to allow a polluted stream to flow therethrough. The polluted stream 8 flows into the device at the first open axial end 26 of the duct 1, is treated within the bore 30 of the duct, and the treated stream 10 flows out of the second open axial end 28 of the duct. It should be realized, of course, that the polluted stream inlet and treated stream outlet need not necessarily be formed as open axial ends 26, 28 of the duct 1, and could be ports or openings formed through the thickness of the duct sidewall and situated near opposite axial ends of the duct, which axial ends may be closed.

In the embodiment shown in FIGS. 1A and 1B, the duct 1 is shown as being cylindrical in shape; however, it is envisioned to be within the scope of the present invention to have the duct take on a rectangular, polygonal or other shape in cross-section. The duct 1 of the other embodiments of the present invention may be so similarly shaped.

The device includes a shaft 5 extending axially centrally through the bore 30 of the duct. The shaft 5 is coupled to a motor 9, as illustrated by FIG. 1A. The duct 1 is connected to the shaft 5 by a plurality of electrically insulating spokes 32, so that when the shaft 5 is rotated by the motor 9, the duct 1 rotates with it. Preferably, both the duct 1 and the shaft 5 are formed from an electrically conductive material, such as metal.

High potential electrodes 4 in the form of wires 34 extend axially along at least a portion of the longitudinal length of the shaft 5, and are preferably spaced orthogonally about the circumference of the shaft. The opposite ends of the high potential wire electrodes 34 are preferably attached to the shaft 5 by electrically conductive spacers 6 in the form of pins mounted to and extending radially outwardly from the exterior surface of the shaft 5 orthogonally about the circumference of the shaft, with the ends of the wire electrodes 34 being attached to the free ends of the spacers 6.

Similarly, low potential electrodes 2 in the form of wires 36 extend axially along at least a portion of the longitudinal length of the duct 1 within the bore 30 and are situated orthogonally about the circumference of the interior surface of the duct. The opposite ends of the low potential wire electrodes 36 are preferably attached to the free ends of electrically conductive spacers 3 which are mounted to and extend radially outwardly from the interior surface of the duct 1 orthogonally about the circumference of the interior surface of the duct. The low potential wire electrodes 36 are situated in alignment with corresponding high potential wire electrodes 34, as illustrated by FIG. 1B of the drawings. The distance D between aligned high potential electrodes 4 and low potential electrodes 2 is preferably about 10 centimeters (cm) when a voltage difference applied to the high potential electrodes and low potential electrodes is about 100 kilovolts (kV). Preferably, the duct 1 is grounded or at ground potential.

More specifically, a high voltage power supply 7 is connected to the low potential wire electrodes 36 and high potential wire electrodes 34 either directly or through the duct 1, the shaft 5 and the spacers 3, 6.

The motor 9 rotates the shaft 5 and the high potential wire electrodes 34 connected thereto, and the duct 1 and the low potential wire electrodes 36 connected thereto, preferably with the same angular speed ω in the same direction. In this manner, the low potential electrodes 2 and the high potential electrodes 4 cross the polluted stream 8 at a relatively high linear or tangential speed that is preferably in the range of about 50 meters per second (m/s) to about 100 meters per second (m/s). The rotation of the shaft 5, duct 1, low potential electrodes 2 and high potential electrodes 4 help stir and mix the polluted stream 8, causing most if not all of the stream to be exposed to the corona discharge and the ionization which occurs between the high potential electrodes 4 and the low potential electrodes 2 in the interelectrode space. The centrifugal forces imposed on the stream by the rotation of the components of the device benefit the removal of particulates in this embodiment of the present invention.

The distance D between the low potential wire electrodes 36 and the high potential wire electrodes 34 is chosen in such a way that a corona discharge is formed upon the application of a high voltage. This distance depends on the amplitude and form of the high voltage applied, that is, whether it is DC (direct current), AC (alternating current), a pulsed voltage or a combination or superposition of the aforementioned voltages, the rotational velocity of the electrodes, the pressure of the gaseous or aerosol stream flowing through the bore 30 of the duct, the temperature of the stream, and other factors, and can be chosen properly by those skilled in the art.

The distance D may be graded, that is, increased downstream, from the inlet open axial end 26 of the duct 1 towards the outlet open axial end 28 of the duct, in view of the decrease in the relative rotational speed of the low potential electrodes 2 and the high potential electrodes 4 with respect to the gaseous or aerosol stream caused by the entrapment of the stream within the bore 30 of the duct, and the formation of ionized species, whose concentration increases towards the stream outlet axial open end 28 of the duct.

It should be understood by those skilled in the art that, alternatively, two separate motors can be provided to rotate the duct 1 and low potential electrodes 2 electrically coupled thereto, and the shaft 5 with its high potential electrodes 4 connected thereto, in opposite directions or the same direction, and at different speeds in any direction. The high voltage power supply 7 may be rotated together with the duct 1 or shaft 5 and the low potential electrodes 2 and high potential electrodes 4 respectively electrically coupled thereto and connected to the electrodes by means known in the art, for example, by slip rings.

It should be understood, of course, that the high potential electrodes 4 and the low potential electrodes 2 may be reversed, with the low potential electrodes 2 being situated on the shaft 5, and the high potential electrodes 4 being situated on the duct 1. Furthermore, either the shaft 5 or the duct 1 may be grounded, or neither may be grounded. The interchangeability of the low potential electrodes 2 with the high potential electrodes 4, and the grounding of either the high potential electrodes 4 or the low potential electrodes 2, apply to the other embodiments of the present invention described herein.

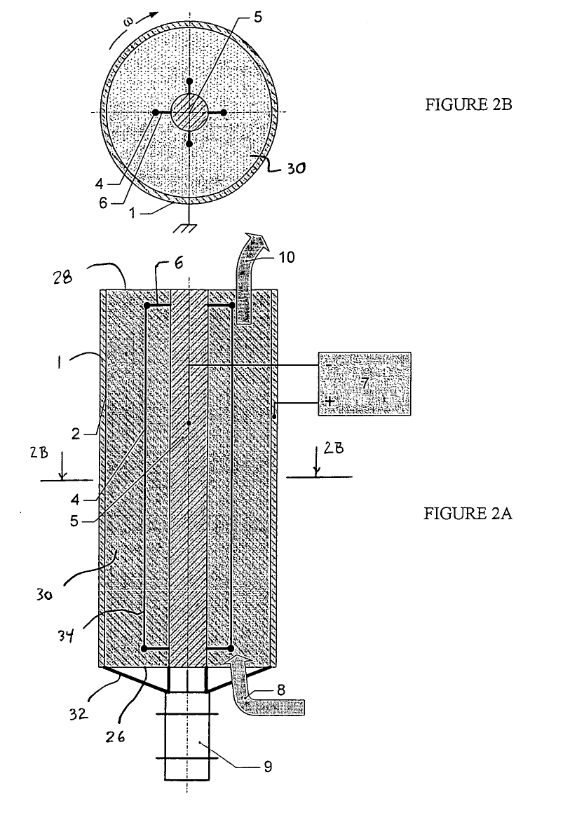

A second embodiment of the present invention is illustrated by FIGS. 2A and 2B of the drawings. In this embodiment, which is similar in many respects to the first embodiment illustrated by FIGS. 1A and 1B, the duct 1 itself constitutes the low potential electrode 2; that is, the low potential wire electrodes 36 and spacers 3 connected thereto are eliminated. The remaining structure of the second embodiment is similar to that of the first embodiment, and the same reference numerals used in the first and second embodiments denote the same or similar structure. Again, it should be realized that the duct 1 may constitute a high potential electrode, and the wire electrodes 34, spacers 6 and shaft 5 may constitute the low potential electrode, and either the duct 1 or the wire electrodes 34, spacers 6 and shaft 5 may be grounded, or none of these components may be grounded.

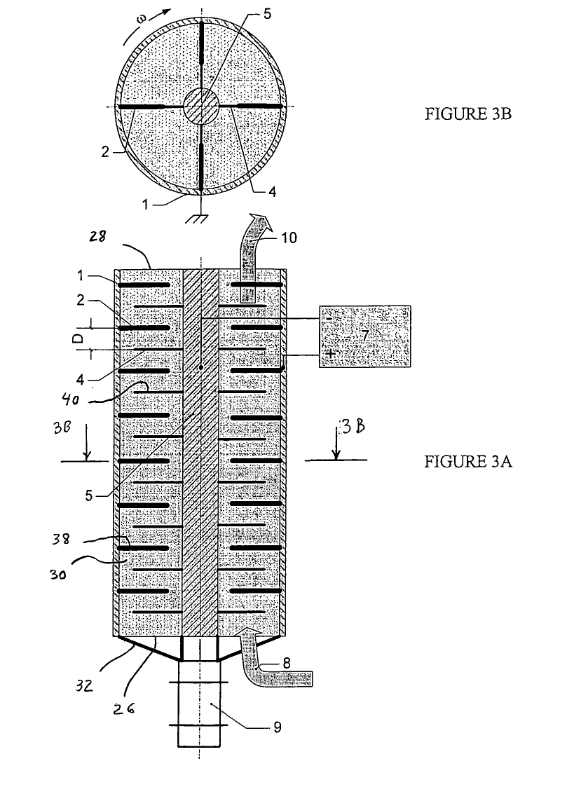

A third embodiment of a device for the remediation of gaseous and aerosol streams constructed in accordance with the present invention is illustrated by FIGS. 3A and 3B of the drawings. Here, the wire-to-wire electrode system of the first embodiment shown in FIGS. 1A and 1B is implemented as a set of low potential pins 38 and a set of high potential pins 40. More specifically, a set of high potential electrodes 4 is formed as a plurality of electrically conductive pins 40 that extend radially outwardly from the exterior surface of the central shaft 5 extending axially through the bore 30 of the duct 1 and preferably spaced apart orthogonally about the circumference of the shaft 5. A set of low potential electrodes 2 is formed as a plurality of electrically conductive pins 38 which extend radially outwardly from the interior surface of the duct 1 and are spaced apart orthogonally about the circumference of the interior surface of the duct. The low potential pins 38 are situated in radial alignment with corresponding high potential pins 40. The low potential pins 38 are spaced apart periodically axially along at least a portion of the longitudinal length of the duct 1, and the high potential pins 40 are spaced apart axially along at least a portion of the longitudinal length of the shaft 5. However, the low potential pins 38 are offset axially in the bore 30 of the duct from the high potential pins 40, and the length of the low potential pins 38 and the length of the high potential pins 40 are such that free end portions of the low potential pins 38 and free end portions of corresponding high potential pins 40 adjacent to the low potential pins 38 overlap one another in an axially interleaved arrangement through the bore 30 of the duct 1 between the interior surface of the duct and the exterior surface of the shaft 5. Again, like the other embodiments, a high voltage power supply 7 is connected between the shaft 5 and the duct 1, preferably with the high potential electrode pins 40 being electrically coupled to the shaft 5 and the low potential electrode pins 38 being electrically coupled to the duct 1, and with the duct grounded or at ground potential. However, as stated previously, the low potential electrode pins 38 may, instead, be mounted on the shaft 5, and the high potential electrode pins 40 may be mounted on the duct 1, with either the duct 1 or the shaft 5 grounded, or neither the duct or the shaft grounded.

Additionally, either a single motor 9 may be used to rotate both the shaft 5 and the electrode pins 40 connected thereto, and the duct 1 and the electrode pins 38 connected thereto, or separate motors can be provided for rotating the duct 1 and shaft 5 and their respective electrode pins 38, 40 in the same direction, or in opposite directions, and at the same speed or at different speeds, as in the case with the first and second embodiment shown in FIGS. 1A and 1B, and 2A and 2B, respectively.

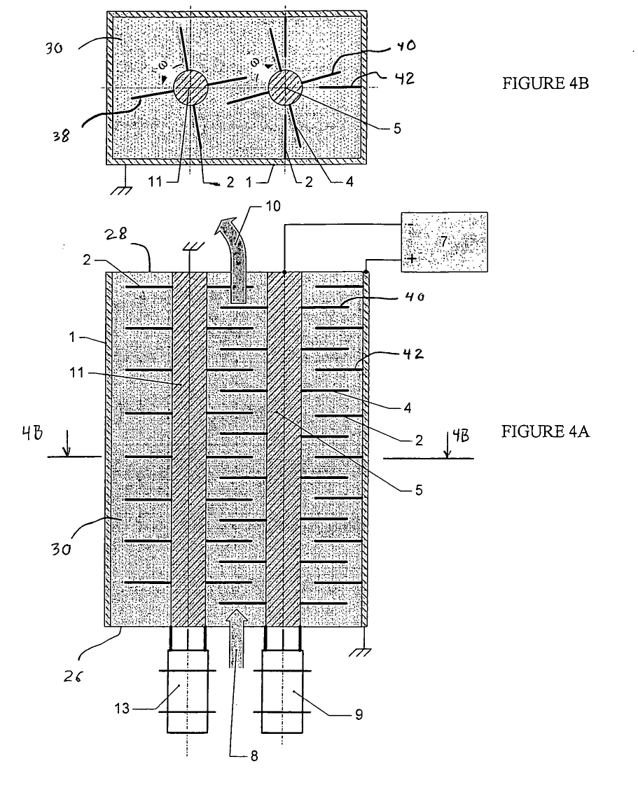

A fourth embodiment of the present invention is illustrated by FIGS. 4A and 4B of the drawings. As in the other embodiments, the same reference numbers used in FIGS. 4A and 4B depict the same or similar structure shown in the other embodiments described herein. An objective of the structure of the device of the present invention shown in FIGS. 4A and 4B is to increase the corona discharge volume while preventing arcing between adjacent opposite polarity electrode pins. The structure of the device illustrated by FIG. 4A and FIG. 4B of the drawings is similar in many respects to the device illustrated by FIGS. 3A and 3B, described previously.

More specifically, within the bore 30 of the duct are axially situated a first shaft 5 and a second shaft 11. The first shaft 5 and the second shaft 11 are disposed parallel to one another in their axially extending directions. The first shaft 5 is formed from an electrically conductive material, as in the previous embodiments, and includes a set of high potential electrodes 4 formed as a plurality of pins 40 extending radially outwardly from the exterior surface of the first shaft 5 and spaced apart orthogonally about the circumference of the first shaft, and spaced apart axially along at least a portion of the longitudinal length of the first shaft 5, as in the third embodiment shown in FIGS. 3A and 3B. The first shaft 5 is coupled to and driven by a first motor 9.

The second shaft 11 similarly includes a set of low potential electrodes 2 in the form of a plurality of pins 38 which extend radially outwardly from the exterior surface of the second shaft 11 and spaced apart orthogonally about the circumference of the second shaft. The low potential electrode pins 38 of the second shaft 11 are situated axially along at least a portion of the longitudinal length of the second shaft. As with the embodiment shown in FIGS. 3A and 3B, the low potential electrode pins 38 are spaced axially apart from one another on the second shaft 11, and the high potential electrode pins 40 of the first shaft 5 are spaced apart axially on the first shaft in such a manner that the low potential electrode pins 38 are offset axially from the high potential electrode pins 40, and the length of each low potential electrode pin 38 and the length of each high potential electrode pin 40 are such that the free ends of opposite polarity electrode pins overlap and are axially adjacent to one another to form an interleaved arrangement of opposite polarity pins axially along at least portions of the longitudinal lengths of the first and second shafts 5, 11, in the same manner as was described with respect to the third embodiment shown in FIGS. 3A and 3B.

The second shaft 11 is coupled to and driven by a second motor 13, which causes the second shaft 11 and the low potential electrode pins 38 mounted thereon to rotate, the low potential electrode pins 38 of the second shaft 11 rotating between the high potential electrode pins 40 of the first shaft 5. Preferably, the second shaft 11 is electrically conductive. A high voltage power source 7 is connected between the duct 1 and the first shaft 5 having the high potential electrode pins 40 mounted thereon. Preferably, the second shaft 11 having the low potential electrode pins 38 mounted thereon, and the duct 1, are grounded.

In this fourth embodiment, there are preferably additional low potential electrode pins 42 which extend into the bore 30 of the duct 1 perpendicularly from the interior surface or surfaces thereof. Such low potential electrode pins 42 are stationary, and are preferably situated in at least three orthogonally spaced apart columns extending axially through the bore 30 of the duct and in diametrical alignment with the rotatable first shaft 5 having the high potential electrode pins 40 mounted thereon. The low potential electrode pins 42 of each column that are mounted on the interior surface or surfaces of the duct 1 are spaced apart from each other in an axial direction in a manner similar to the low potential electrode pins 38 mounted on the second shaft 11. The low potential electrode pins 42 mounted on the interior surface or surfaces of the duct 1 extend into the bore 30 a sufficient distance such that the free ends thereof overlap the free ends of the high potential electrode pins 40 mounted on the first shaft 5. Thus, the low potential electrode pins 42 of the interior surface of the duct 1 are interleaved axially with the high potential electrode pins 40 of the first shaft 5 in a manner similar to the low potential electrode pins 38 of the second shaft 11 with respect to the high potential electrode pins 40 of the first shaft 5. The interleaved, adjacent, overlapping portions of the high potential electrode pins 40 of the first shaft 5 and the low potential electrode pins 42, 38 of the interior surface of the duct 1 and the second shaft 11 result in a corona discharge between them and an ionization of the gaseous or aerosol stream flowing between them, which increases the corona discharge volume of the device and provides a more efficient removal of pollutants and particulates from the gaseous or aerosol stream flowing through the bore 30 of the duct.

The first and second motors 9, 13 may respectively rotate the first and second shafts 5, 11 in opposite directions and at the same rotational speed ω, as illustrated by FIG. 4B, or in the same direction, or at different rotational speeds. Also, as mentioned previously, the position of the high potential electrodes 4 and the low potential electrodes 2 may be reversed, and the first shaft 5 may be grounded while the second shaft 11 and duct 1 are ungrounded, or none of the electrodes may be grounded.

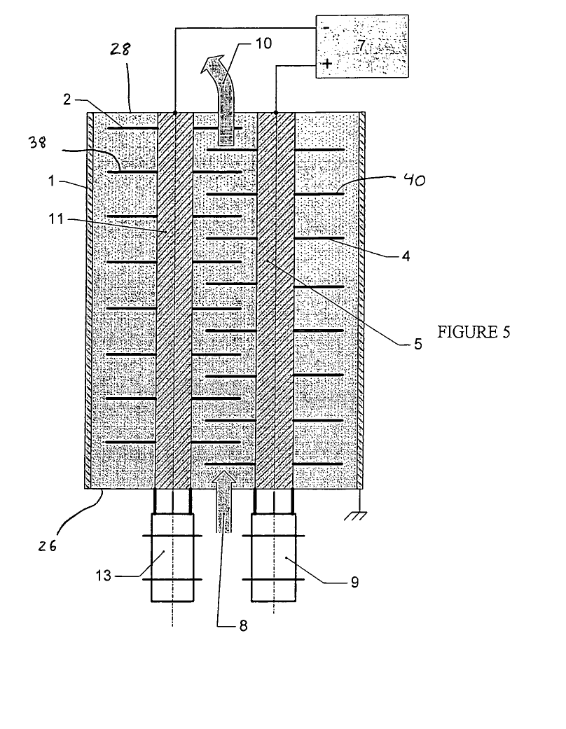

A fifth embodiment of the present invention is illustrated by FIG. 5. This embodiment is very similar to the fourth embodiment described previously and shown in FIGS. 4A and 4B, except that in this fifth embodiment, no electrode pins 42 extend from the interior surface of the duct, and the high voltage power source 7 is connected to the first and second shafts 5, 11 in a different manner than that shown in FIGS. 4A and 4B. Therefore, the same reference numbers used in FIG. 5 depict the same or similar structural components shown in FIGS. 4A and 4B.

In the fifth embodiment illustrated by FIG. 5, the device for the remediation of gaseous and aerosol streams shown therein has a bipolar power supply 7 that provides a high voltage output of positive and negative polarity to the first shaft 5 and the second shaft 11, respectively, and the high potential electrode pins 40 and the low potential electrode pins 38 respectively mounted thereon. The duct 1 is preferably grounded in this embodiment. This fifth embodiment is particularly suitable for the remediation of polluted streams having no particulates.

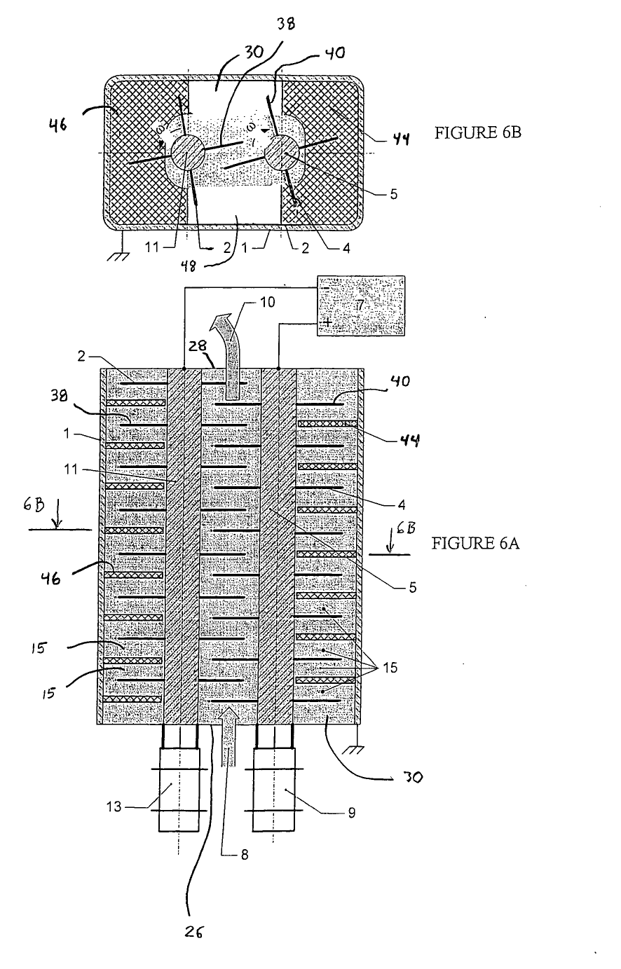

FIGS. 6A and 6B of the drawings illustrate a sixth embodiment of the present invention. This sixth embodiment is similar in structure to the fifth embodiment described previously and shown in FIG. 5, and the reference numbers used therein depict components which are the same or similar to those of the fifth embodiment. However, in the sixth embodiment, a plurality of spaced apart insulating separators 44, 46 are mounted to and extend perpendicularly from the interior surface or surfaces of the duct 1 inwardly of the bore 30.

More specifically, a first column of spaced apart electrically insulating plate-like separators 44 extend inwardly of the bore 30 between the first shaft 5 and the interior surface or surfaces of the duct 1, each first separator 44 being situated between adjacent electrode pins 40 of the first shaft 5 in an axially interleaved arrangement. A column of second plate-like separators 46 extend between the second shaft 11 and the interior surface or surfaces of the duct 1. The second separators 46 are also electrically non-conducting, and are spaced apart from one another axially in the bore 30 such that there is a second separator 46 situated between adjacent electrode pins 38 of the second shaft 11. In this embodiment, the high polarity side of the high voltage power supply 7 is coupled to the first shaft 5, and the low polarity side of the high voltage power supply 7 is coupled to the second shaft 11, with the duct 1 being grounded. Each of the first and second shafts 5, 11 is rotated by the first motor 9 and the second motor 13, respectively, in the same manner as described with respect to the fifth embodiment illustrated by FIG. 5 of the drawings.

The insulating first and second separators 44, 46 effectively block the flow of the gaseous or aerosol stream through regions 15 of the bore 30 between the interior surface or surfaces of the duct 1 and the first and second shafts 5, 11 where, in these regions 15, the electrode pins 40, 38 of the first and second shafts do not overlap and corona discharge is weak or absent due to a weak electric field. The gaseous or aerosol stream is forced by the separators 44, 46 to flow in the central area 48 of the bore 30 between the first and second shafts 5, 11 and the overlapping low and high electrode pins 38, 40 where the electric field is strong. Such separators 44, 46 may be added to the fourth embodiment and fifth embodiment illustrated respectively by FIGS. 4A and 4B and FIG. 5 of the drawings.

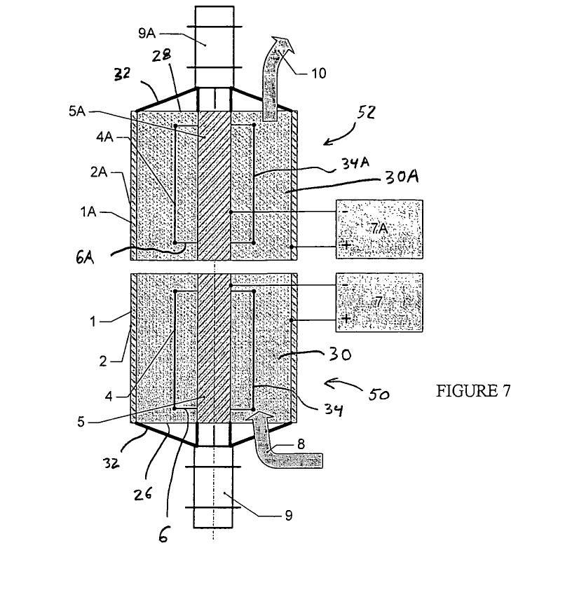

In a seventh embodiment of the present invention, the device for the remediation of gaseous and aerosol streams may be segmented axially, as illustrated by FIG. 7 of the drawings. The structure of the seventh embodiment is similar to that of the second embodiment described previously and shown in FIGS. 2A and 2B of the drawings. Therefore, reference numbers used in FIG. 7 depict the same or similar structure as that of the second embodiment shown in FIGS. 2A and 2B and referred to therein by the same reference numbers.

In this seventh embodiment of the present invention, the duct 1 and the electrode wires 34 are sectioned in two parts, that is, a first axial part 50 and a second axial part 52 situated adjacent to the first axial part 50. The first axial part 50 is coupled to a motor 9, which rotates the first axial part 50 in one direction. The second axial part 52 is coupled to a second motor 9A which rotates the second axial part 52 in a second direction, which may be the same direction as the first axial part, but is preferably in an opposite direction from the direction in which the first axial part 50 is rotated. As can be seen from FIG. 7, the first axial part 50 includes a first electrically conductive shaft 5, first electrode 4 having wires 34 and first electrically conductive spacers 6, and a first axial portion 1 of the duct. The first axial portion 1 of the duct is connected to one polarity of a first power supply 7, with the first shaft 5 being electrically coupled to the opposite polarity of the first high voltage power supply 7.

Similarly, the second axial part 52 of the device includes a second electrically conductive shaft 5A coupled to the second motor 9A, second electrodes 4A having wires 34A and second electrically conductive spacers 6A, and a second axial portion 1A of the duct. A second high voltage power supply 7A is provided in which one polarity of the voltage supply is coupled to the second axial portion 1A of the duct, and the opposite polarity of the second power supply is electrically coupled to the second shaft 5A. The first axial part 50 and the second axial part 52 of this device are in axial alignment with one another, with the respective first and second bores 30, 30A defined by the first and second segmented duct portions 1, 1A being in fluid communication.

The advantage of using the device of the present invention illustrated by FIG. 7 is that the total rotational moment of the device is brought to zero, and the tangential component of the stream velocity accumulated due to the flow entrapment of the stream from the inlet open axial end 26 where the polluted stream 8 enters the device to the outlet open axial end 28 of the device where the treated stream 10 exits the device is effectively used to remove pollutants and particulates from the gaseous or aerosol stream flowing therethrough. Furthermore, the rotational component imparted on the gaseous or aerosol stream flowing through the first part 50 of the device due to the rotation of the first part 50 in one direction is eliminated or minimized as the gaseous or aerosol stream flows through the second part 52 of the device which is preferably rotating in an opposite direction to that of the first part 50 so that the treated stream exiting the second part 52 of the device has effectively no rotational component of its flow.

It should be realized, of course, that although only two axial parts 50, 52 of the device are illustrated by FIG. 7, the device may be segmented into any number of axially disposed sections or parts, with adjacent sections preferably rotating in opposite directions.

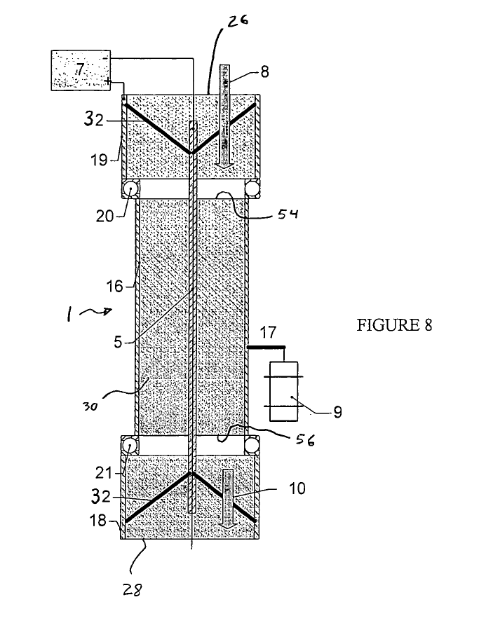

An eighth embodiment of the present invention is illustrated by FIG. 8 of the drawings. The objective of this eighth embodiment is to eliminate the rotational movement of either the high potential electrodes 4 or the low potential electrodes 2. In this embodiment, the duct 1 defining the bore 30 is divided into three axial segments. A first outer segment 19 of the duct 1 is coupled to a central shaft 5 extending axially through the bore 30 by a plurality of insulating (non-electrically conducting) spokes 32. A polluted gaseous or aerosol stream 8 enters a first open axial end 26 of the duct 1 situated at the first outer segment 19, which first open axial end 26 is in fluid communication with the bore 30 of the duct.

Similarly, a second outer segment 18 of the duct 1 is situated axially opposite the first outer segment 19 and is coupled to the central shaft 5 at an opposite axial end thereof by a plurality of insulating (non-electrically conductive) spokes 32. The second outer segment 18 of the duct 1 has a second open axial end 28 which serves as an outlet through which the treated gaseous or aerosol stream 10 flows, and is in fluid communication with the bore 30 of the duct.

The device includes a middle segment 16 of the duct 1 which is interposed between the two outer segments 18, 19. The middle segment 16 has two open axial ends 54, 56 which are coupled to the first and second outer segments 19, 18 of the duct by first and second bearings 20, 21, respectively, so that the middle segment 16 of the duct may rotate relative to the first and second outer segments 19, 18 of the duct. For this purpose, a motor 9 is provided, the shaft of which is coupled to the middle segment 16 by a belt 17, gearing or the like to cause the middle segment 16 to rotate. Preferably, in this eighth embodiment, the two outer segments 18, 19 of the duct 1 are stationary.

The two outer segments 18, 19 and the middle segment 16 of the duct are electrically conductive and form a first electrode 2, which first electrode 2 is coupled to one polarity of a high voltage power supply 7, as illustrated by FIG. 8. The central shaft 5 that extends through the two outer segments 18, 19 and the middle segment 16 of the duct within the bore 30 defined by the duct 1 is also electrically conductive and defines a second electrode 4, the second electrode 4 being electrically coupled to an opposite polarity of the high voltage power supply 7. It is envisioned to be within the scope of the present invention to reverse the polarities of the first and second electrodes (i.e., the duct segments 16, 18, 19 and the shaft 5, respectively), and to either ground the two outer segments 18, 19 and middle segment 16 of the duct 1 or to ground the shaft 5, or to not ground either the duct 1 or the shaft 5. Also, the shaft 5 may include pin electrodes 40 or wire electrodes 34 mounted thereon, as disclosed in the previous embodiments, and the outer segments 18, 19 and middle segment 16 of the duct 1 may include pin electrodes 42 or wire electrodes 36 as disclosed in previous embodiments.

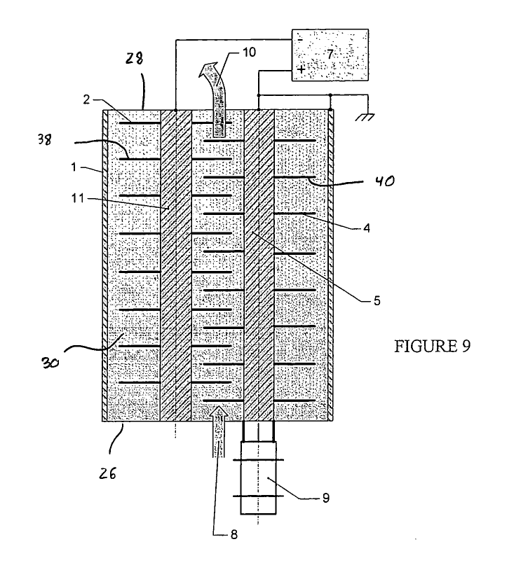

A ninth embodiment of the present invention is illustrated by FIG. 9 of the drawings. The structure of this ninth embodiment is similar in many respects to that of the fourth embodiment illustrated by FIGS. 4A and 4B, and the fifth embodiment illustrated by FIG. 5. Accordingly, the components of the ninth embodiment shown in FIG. 9 which have the same reference numbers as those shown in FIGS. 4A and 4B and FIG. 5 depict the same or similar structure to those components shown in FIGS. 4A, 4B and 5.

In this ninth embodiment, the second motor 13 coupled to the second shaft 11 of the fourth embodiment and fifth embodiment illustrated respectively by FIGS. 4A and 4B and FIG. 5 is omitted such that the low potential electrode assembly 2 comprising the second shaft 11 and electrode pins 38 stays immovable, whereas the high potential electrode assembly 4 comprising the first shaft 5 and the electrode pins 40 mounted thereon are rotated by the first motor 9. In this ninth embodiment, the duct 1 and rotatable first shaft 5 are grounded, as is the positive (+) polarity side of the power supply 7. The negative (−) polarity side of the power supply 7 is electrically coupled to the non-rotatable second shaft 11.

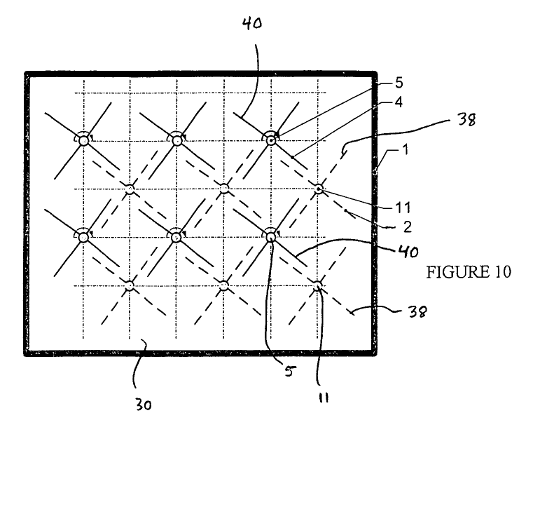

The tenth embodiment of the present invention, which is illustrated by FIG. 10 of the drawings, is provided for increasing the device treatment capacity. Effectively, the structure of the ninth embodiment illustrated by FIG. 9 is extended using a checker mesh structure as shown in FIG. 10. Thus, the components depicted by reference numbers in FIG. 10 which are the same reference numbers as those shown in FIG. 9 have the same or similar structure.

The discharge zone resides between the low potential electrode pins 38 (low potential electrodes 2) mounted on the stationary second shafts 11, and the grounded high potential electrode pins 40 (high potential electrodes 4) mounted on the rotating first shafts 5. Thus, with this tenth embodiment, there are a multiplicity of adjacent stationary and rotatable shafts 11, 5 extending axially though the bore 30 of the duct, with each shaft carrying opposite polarity electrode pins 38, 40 which overlap one another in an axially interleaved arrangement through the bore of the duct.

It should be evident from the foregoing description of the illustrative embodiments of the present invention that a device for the remediation of gaseous and aerosol streams may be constructed with one or more rotating electrode assemblies. By having such, not only will the polluted stream flowing through the device be mixed to ensure that the stream is exposed to regions of high electric field and corona discharge between the electrodes, but also higher potentials between opposite polarity electrodes to effect a corona discharge without causing arcing may be achieved. The result is a more efficient and effective device for removing particulates and pollutants from the gaseous or aerosol stream.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A device for remediation of gaseous or aerosol streams, which comprises:
an elongated duct, the elongated duct having an inlet opening for inputting a gaseous or aerosol stream and an outlet opening for outputting the gaseous or aerosol stream, and defining an interior bore in fluid communication with the inlet opening and the outlet opening for the axial flow and passage of the gaseous or aerosol stream therethrough; and
at least one high potential electrode, and at least one low potential electrode, the at least one high potential electrode and the at least one low potential electrode being separated from each other and being situated at least one of on the duct and within the bore of the duct, at least one of the at least one high potential electrode and the at least one low potential electrode being rotatable with respect to the axial flow of the gaseous or aerosol stream through the bore of the duct, the at least one high potential electrode and the at least one low potential electrode being electrically communicatable with a source of high voltage to effect a corona discharge between the at least one high potential electrode and the at least one low potential electrode.

2. A device for remediation of gaseous or aerosol streams as defined by claim 1, which further comprises at least one shaft extending at least partially axially through the bore of the duct.

3. A device for remediation of gaseous or aerosol streams as defined by claim 2, wherein the at least one shaft is rotatable within the bore of the duct.

4. A device for remediation of gaseous or aerosol streams as defined by claim 2, wherein at least one of the at least one high potential electrode and the at least one low potential electrode includes the at least one shaft.

5. A device for remediation of gaseous or aerosol streams as defined by claim 2, wherein at least one of the at least one high potential electrode and the at least one low potential electrode includes the duct.

6. A device for remediation of gaseous or aerosol streams as defined by claim 2, wherein the at least one shaft includes a plurality of pins mounted thereon and extending radially outwardly therefrom, the pins being arranged in a spaced apart relationship from each other axially and circumferentially on the at least one shaft, at least one of the at least one high potential electrode and the at least one low potential electrode including the plurality of pins mounted on the at least one shaft.

7. A device for remediation of gaseous or aerosol streams as defined by claim 2, wherein the duct includes an interior surface, and a plurality of pins mounted thereon and extending radially outwardly from the interior surface thereof and into the bore of the duct, the pins being arranged in a spaced apart relationship from each other axially and circumferentially on the duct, at least one of the at least one high potential electrode and the at least one low potential electrode including the plurality of pins mounted on the duct.

8. A device for remediation of gaseous or aerosol streams as defined by claim 2, wherein the at least one shaft includes a plurality of wires mounted thereon, each wire of the plurality of wires extending axially at least partially along the length of the at least one shaft, the wires being arranged in a spaced apart relationship from each other circumferentially on the at least one shaft, at least one of the at least one high potential electrode and the at least one low potential electrode including the plurality of wires mounted on the at least one shaft.

9. A device for remediation of gaseous or aerosol streams as defined by claim 8, wherein the at least one shaft has an exterior surface; wherein the wires of the plurality of wires are spaced apart from the exterior surface of the at least one shaft; and wherein the at least one shaft includes a plurality of spacers mounted on the exterior surface of the at least one shaft and extending outwardly therefrom, the wires being attached to the spacers.

10. A device for remediation of gaseous or aerosol streams as defined by claim 2, wherein the duct includes an interior surface, and a plurality of wires mounted on the interior surface, each wire of the plurality of wires extending axially at least partially along the length of the duct, the wires being arranged in a spaced apart relationship from each other circumferentially on the interior surface of the duct, at least one of the at least one high potential electrode and the at least one low potential electrode including the plurality of wires mounted on the duct.

11. A device for remediation of gaseous or aerosol streams as defined by claim 10, wherein the wires of the plurality of wires are spaced apart from the interior surface of the duct; and wherein the duct includes a plurality of spacers mounted on the interior surface of the duct and extending outwardly therefrom and into the bore of the duct, the wires being attached to the spacers.

12. A device for remediation of gaseous or aerosol streams as defined by claim 2, wherein the at least one shaft includes a first shaft and a second shaft, the first and second shafts being in a parallel arrangement with each other; and wherein at least one of the first and second shafts is rotatable within the bore of the duct.

13. A device for remediation of gaseous or aerosol streams as defined by claim 12, wherein each of the first and second shafts is rotatable.

14. A device for remediation of gaseous or aerosol streams as defined by claim 12, wherein the first shaft includes a plurality of first pins mounted thereon and extending radially outwardly therefrom, the first pins being arranged in a spaced apart relationship from each other axially and circumferentially on the first shaft, the at least one high potential electrode including the first shaft and the plurality of first pins mounted thereon;
wherein the second shaft includes a plurality of second pins mounted thereon and extending radially outwardly therefrom, the second pins being arranged in a spaced apart relationship from each other axially and circumferentially on the second shaft, the at least one low potential electrode including the second shaft and the plurality of second pins mounted thereon;
and wherein the first shaft and the second shaft are arranged adjacent to one another such that at least portions of the first pins mounted on the first shaft overlap radially at least portions of the second pins mounted on the second shaft, the first pins mounted on the first shaft being offset axially within the bore of the duct from the second pins mounted on the second shaft.

15. A device for remediation of gaseous or aerosol streams as defined by claim 2, wherein the duct and the at least one shaft are rotatable in the same direction.

16. A device for remediation of gaseous or aerosol streams as defined by claim 2, wherein the duct is rotatable in a first direction, and the at least one shaft is rotatable in a second direction, the first direction being different from the second direction.

17. A device for remediation of gaseous or aerosol streams as defined by claim 1, wherein the duct, the at least one high potential electrode and the at least one low potential electrode are segmented axially to respectively provide at least first and second segmented duct portions, at least one first and one second segmented high potential electrode portions, and at least one first and one second segmented low potential electrode portions, the first segmented duct portion defining a first interior bore, and the second segmented duct portion defining a second interior bore, the first and second segmented duct portions being arranged with respect to one another such that the first interior bore of the first segmented duct portion is in fluid communication with the second interior bore of the second segmented duct portion, the at least one first segmented high potential electrode portion and the at least one first segmented low potential electrode portion being separated from each other and being situated at least one of on the first segmented duct portion and within the first interior bore of the first segmented duct portion, at least one of the at least one first segmented high potential electrode portion and the at least one first segmented low potential electrode portion being rotatable with respect to the axial flow of the gaseous or aerosol stream through the first interior bore of the first segmented duct portion, the at least one first segmented high potential electrode portion and the at least one first segmented low potential electrode portion being electrically communicatable with a first source of high voltage to effect a corona discharge between the at least one first high potential electrode portion and the at least one first low potential electrode portion, the at least one second segmented high potential electrode portion and the at least one second segmented low potential electrode portion being separated from each other and being situated at least one of on the second segmented duct portion and within the second interior bore of the second segmented duct portion, at least one of the at least one second segmented high potential electrode portion and the at least one second segmented low potential electrode portion being rotatable with respect to the axial flow of the gaseous or aerosol stream through the second interior bore of the second segmented duct portion, the at least one second segmented high potential electrode portion and the at least one second segmented low potential electrode portion being electrically communicatable with a second source of high voltage to effect a corona discharge between the at least one second high potential electrode portion and the at least one second low potential electrode portion.

18. A device for remediation of gaseous or aerosol streams as defined by claim 17, wherein the first segmented duct portion is rotatable relative to the second segmented duct portion.

19. A device for remediation of gaseous or aerosol streams as defined by claim 18, wherein the first segmented duct portion is rotatable, and the second segmented duct portion is non-rotatable.

20. A device for remediation of gaseous or aerosol streams as defined by claim 17, wherein the first segmented duct portion is rotatable in a first direction, and the second segmented duct portion is rotatable in a second direction, the first direction being different from the second direction.
